(19) United States
(12) Patent Application Publication
(10) Pub. No.: US 2006/0219280 A1
(43) Pub. Date: Oct. 5, 2006

(54) Walker foot

(76) Inventors: Earl Robinson, Lake Forest, CA (US); Jeffery Smith, Newport Beach, CA (US)

Correspondence Address: THE MAXHAM FIRM, 750 "B" STREET, SUITE 3100, SAN DIEGO, CA, 92101, US

(21) Appl. No.: 11/097,042

(22) Filed: Mar. 31, 2005

(51) Int. Cl. A61H 3/00; A45B 9/04

(52) U.S. Cl. 135/84

(57) ABSTRACT

In accordance with one embodiment, a foot assembly for use with a walker may include an attachment assembly for engaging a leg tube of the walker. A coupling device, such as a screw, may be used to couple the attachment assembly with a slider foot. The coupling device permits rotational and angular movement between the attachment assembly and the slider foot. In some embodiments, the walker may include three or four legs which are connected by a structure which maintains the legs in a fixed spatial relationship. A separate foot assembly may be affixed to one or more of the legs of the walker.

### BACKGROUND OF THE INVENTION

1. Field of the Invention

The present invention relates generally to a sliding device, and in particular to a sliding foot assembly for engaging a support leg of a walker.

2. Discussion of the Related Art

Presently, a number of different types of walkers have been developed to assist aging and disabled persons. Such walkers enable users to stand and walk relatively freely across level and moderately inclined ground, as well as up and down stairs. Conventional walkers require both strength and stability because an invalid user, for example, must rely upon the walker as their sole or primary source of support. Such walkers are often lightweight, and constructed of an arrangement of aluminum tubing frames.

Many walkers have three, four, or more legs. Each of the legs is generally equipped with a device, such as a wheel or rubber foot, which makes contact with the ground. The wheel or rubber foot provides two primary functions. One function is to provide stable support to the walker, and consequently to the user of the walker. Another function is to allow the user to advance or otherwise move across the ground with minimal effort. Existing devices have made strides to achieve these functions, but improvement is still needed.

### SUMMARY OF THE INVENTION

In accordance with one embodiment, a foot assembly of a unique shape for use with a walker may include an attachment assembly for engaging a leg tube of the walker. The attachment assembly may be designed to accommodate walker legs with varying inside diameters. A coupling device, such as a screw, may be used to couple the attachment assembly with the uniquely shaped slider foot. The coupling device permits rotational and angular movement between the attachment assembly and the slider foot. In some embodiments, the walker may include three or four legs which are connected by a structure which maintains the legs in a fixed spatial relationship. A separate foot assembly may be affixed to one or more of the legs of the walker.

### BRIEF DESCRIPTION OF THE DRAWING

The above and other aspects, features, and advantages of the present invention will become more apparent upon consideration of the following description of preferred embodiments, taken in conjunction with the accompanying drawing figures, wherein:

FIG. 1 is an exploded perspective view a walker foot assembly in accordance with one embodiment of the present invention;

FIG. 2 is an exploded cross-sectional view of the walker foot assembly of FIG. 1;

FIG. 3 is a perspective view of an assembled walker foot assembly;

FIG. 4 is a side view of an assembled walker foot assembly;

FIG. 5 is a cross-sectional view of the assembled walker foot assembly of FIG. 4;

FIG. 6 is a cross-sectional view of the assembled walker foot assembly of FIG. 4, but with the attachment assembly tilted at an angle relative to the slider foot;

FIG. 7 is a cross-sectional view of the attachment assembly of FIG. 1 inserted into the tubular cavity of a walker leg;

FIG. 8 is a cross-sectional view of an attachment assembly of FIG. 1 which is fully deployed inside of the tubular cavity of a walker leg;

FIG. 9 is a cross-sectional view of a walker foot assembly in accordance with an alternative embodiment of the present invention;

FIG. 10 is a perspective view of a four-leg walker having two walker foot assemblies affixed to each of its two front legs; and

FIG. 11 is a perspective view of a three-leg walker having one walker foot assembly affixed to its front leg.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and that structural, as well as procedural, changes may be made without departing from the scope of the present invention.

As a matter of convenience, various embodiments of the invention will be described in the context of a four-leg walking device which implements a walker foot assembly coupled to one or more of its legs. However, the teachings of the present disclosure are equally applicable to walking or support devices (for example, three-leg and four-leg walking canes) for which relatively smooth movement along a surface is desired. Furthermore, various components of a walker foot assembly will be described using exemplary materials, sizes, shapes, and dimensions, but the present invention is not limited to the stated examples.

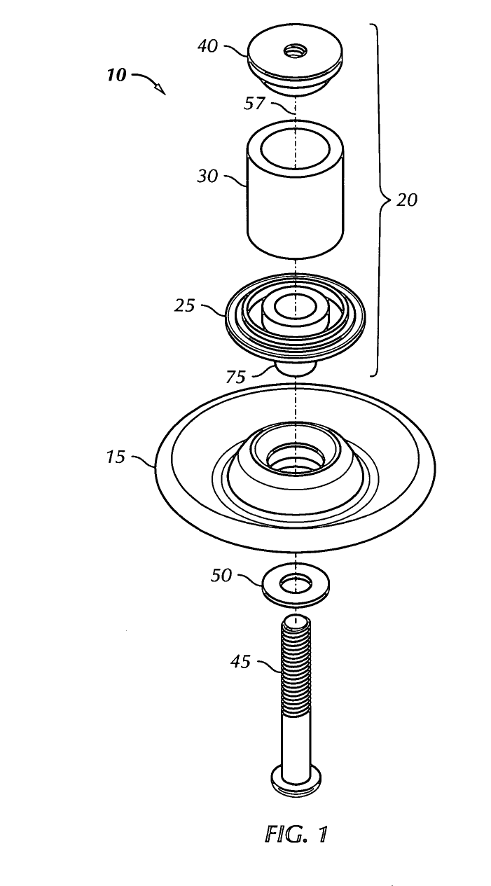

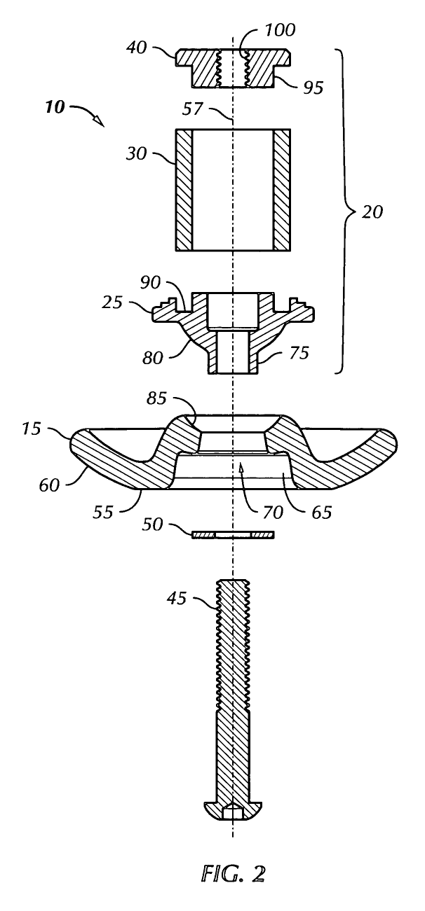

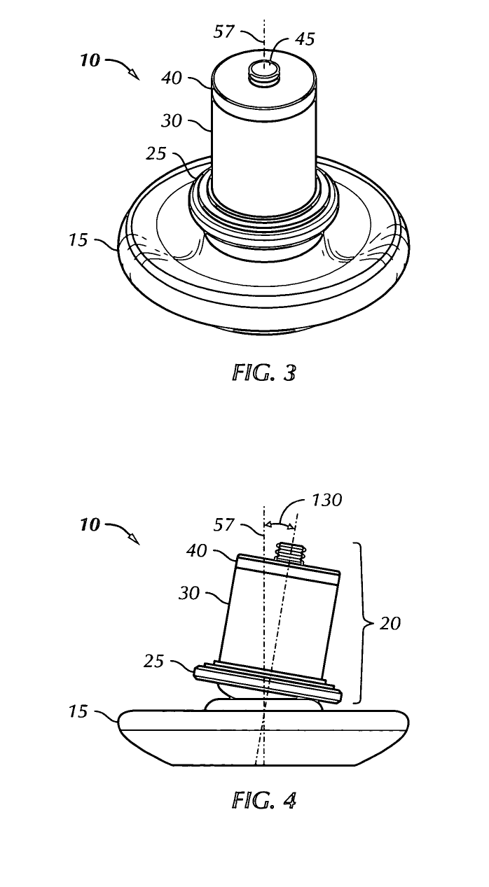

FIGS. 1 and 2 show exploded perspective and cross-sectional views, respectively, of walker foot assembly 10. FIG. 3 is a perspective view of an assembled walker foot assembly. In accordance with an embodiment, the walker foot assembly includes slider foot or glide 15, which may be rotatably coupled to attachment assembly 20. The attachment assembly includes tubing retainer 25, expansion tubing 30, and associated cap 40. A suitable fastener, such as screw 45, may be used to couple the attachment assembly to the slider foot. Optional washer 50 facilitates this coupling.

One purpose of slider foot 15 is to support attachment assembly 20, along with an attached walker (not shown in this figure). The slider foot permits the walker to easily slide or otherwise pass along a surface. The slider foot may be made from a number of different materials which are sufficiently durable to withstand forces encountered during use, and which permits an attached walker to easily slide across a surface. Specific materials which may be used for the slider foot are discussed below.

The slider foot is shown having a substantially flat bottom portion 55. At a radial distance from central axis 57 of the slider foot, the bottom of the foot begins to angle upward to form angled portion 60, which is an optional feature. The angle between angled portion 60 and a plane parallel to bottom portion 55 is shown increasing as a function of radial distance from the central axis. Angled portion 60 allows the slider foot to encounter and negotiate small objects and obstructions which may be present on a surface. Note that angled portion 60 need not be formed at any particular angle.

Slider foot 15 may include cavity 65, which is sized to receive and contain screw 45 and washer 50. The slider foot also includes a centrally located aperture 70, which receives projection 75 of the tubing retainer. Once assembled, curved surface 80 of the retainer engages cooperating curved surface 85 of the slider foot for slideable relative movement. This arrangement permits relative motion (rotational, angular, or both) between attachment assembly 20 and slider foot 15. The diameter of the projection may be sized to form a gap between the projection and the inner wall of aperture 70. This gap permits the attachment assembly and the slider foot to tilt, and to rotate 360° relative to one another. The tilting aspect will be discussed in more detail in conjunction with later figures.

Tubing retainer 25 is shown formed with annular recess 90, which is sized to receive a lower portion of expansion tubing 30. The upper portion of the expansion tubing may be stabilized using tubing cap 40. In the embodiment of FIG. 1, the tubing cap includes annular protrusion 95, which permits the tubing cap to be received by the expansion tubing. The tubing cap may also contain threading 100, which cooperates with the threads of screw 45.

The slider foot, tubing retainer, tubing cap, screw, and washer may be formed from any sufficiently rigid and durable material (for example, plastic, thermo plastic, metal, alloy, and the like), which permits these components to perform their respective functions as part of walker foot assembly 10. Specific examples of materials which may be used for these components include acrylonitrile-butadiene-styrene (ABS), injection molded ultrahigh molecular weight polyethylene (UHMWPE), and injection molded nylon 6/6 plastic, among others.

Expansion tubing 30 may be formed from a material, such as rubber or a thermoplastic elastomer (TPE), that has sufficient durometer and shore, yet pliable under pressure exerted by tubing retainer 25 and tubing cap 40. Extruded acid-resistant neoprene rubber is one of the many types of materials that may be used for the expansion tubing. Slider foot 15 is preferably made from a low friction materials such as PTFE. There are many suitable such materials.

FIG. 4 is a side view of walker foot assembly 10. As previously described, the walker foot assembly may be fabricated so that attachment assembly 20 and slider foot 15 may be rotated 360° relative to each other. That is, the attachment assembly may be rotated about central axis 57 relative to a stationary slider foot, or the slider foot may be rotated about the central axis relative to a stationary attachment assembly, or both of these components may be rotated about the central axis (in either the same or different direction).

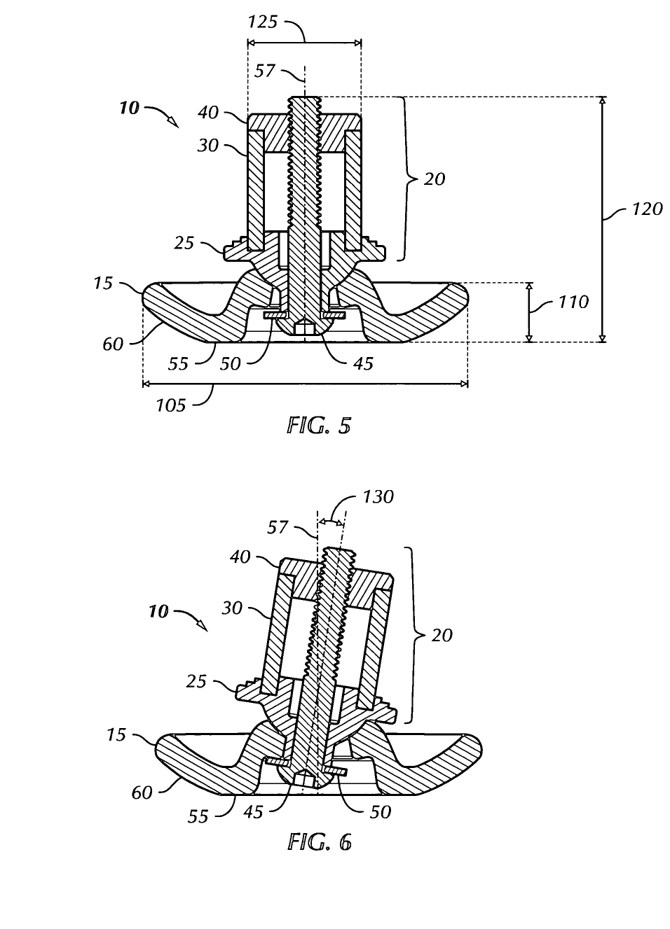

Furthermore, the attachment assembly and slider foot may also be structured so that they individually tilt at an angle relative to each other. For instance, in FIG. 4, attachment assembly 20 is shown positioned at angle 130 relative to central axis 57. In this example, the central axis is perpendicular to the plane in which slider foot 15 lies. Although no particular angle is required, angle 130 typically ranges from about 2° to about 25°, with 4°-10° being preferred in many applications. The cross-sectional views of FIGS. 5 and 6 show the interrelationship of the various components in non-tilted and tilted arrangements, respectively. Specifically, FIG. 5 shows the slider foot positioned substantially perpendicular relative to the slider foot, and FIG. 6 shows the slider foot positioned at an angle relative to the slider foot.

As noted above, no particular size or dimensions are required for the various components of walker foot assembly 10. By way of non-limiting example, the slider foot may be sized so that it has a diameter 105 of about 1.2-4.5 inches, and an overall height 110 of about 0.3-1.3 inches. The overall height 120 of the walker foot assembly may be about 0.75-3.2 inches. In accordance with some embodiments, attachment assembly 20 has diameter 125, which permits this component to be received within a tube leg of a walker (not shown in this figure). Diameter 125 will typically vary in size since the inside diameter of a tube leg of a typical walker also varies. However, in many applications, diameter 125 is about 0.5-1.5 inches. Note further that that the various components are shown having dimensions which are substantially circular, but other geometries (for example, rectangular, oval, and the like), may alternatively be used to meet the needs of a particular application.

It is to be understood that in accordance with some embodiments, slider foot 15 and attachment assembly 20 may be structured so that they individually rotate and tilt relative to each other. This aspect allows the walker foot assembly to more-easily encounter and negotiate uneven surfaces, small objects, and obstructions which may be present on a surface. If desired, the walker foot assembly may alternatively be constructed so that it only provides the above-described rotational movement but does not have the tilting feature. Another alternative is to construct the walker foot assembly so that it only provides the tilting feature, but does not have the rotational feature. Yet another alternative is to construct the walker foot assembly so that it is essentially fixed, such that the attachment assembly and the slider foot neither rotates nor tilts with respect to each other.

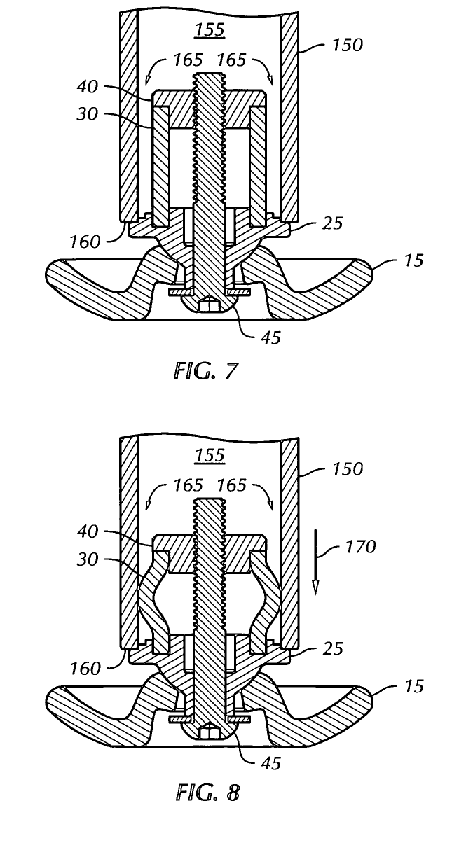

FIG. 7 shows the attachment assembly inserted into the tubular cavity of a leg of an otherwise conventional walker. In this figure, leg tube 150 contains cavity 155, which is sized to receive substantially the entire length of the various components of the attachment assembly. Gaps 165 are formed between an inner wall of leg tube 150 and an outer surface of expansion tubing 30. These gaps facilitate the insertion of the attachment assembly into the cavity of the leg tube.

Note that leg end 160 is in contact with an upper portion of tubing retainer 25. Specifically, the leg end contacts one of three tiered portions of the tubing retainer. Each tiered portion may be designed to engage a leg tube having a different inside diameter. As shown in FIG. 7, the leg end of leg tube 150 is positioned on the outermost tier of tubing retainer 25. The remaining inner-two tiers of the tubing retainer permit the attachment assembly to fit within and engage leg tubes having correspondingly smaller inside diameters.

FIG. 8 shows the same components as FIG. 7, but the walker foot assembly in FIG. 8 is fully deployed. To deploy the walker foot assembly, screw 45 may be rotated, causing tubing cap 40 to move downward in direction 170. This forces expansion tube 30 outward so that it contacts the inner wall of leg tube 150. The walker foot assembly remains within the leg as a result of friction between the expansion tube and the inner wall of the leg tube.

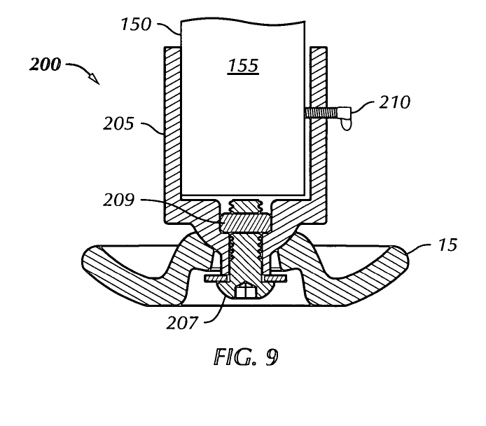

FIG. 9 shows a walker foot assembly coupled to a leg tube according to an alternative embodiment of the present invention. In this embodiment, walker foot assembly 200 is not inserted into the walker leg tube, which is the case in other embodiments. Instead, assembly 200 is sized to receive the end portion of the walker leg tube. Assembly 200 is similar to some respects to assembly 10, but assembly 200 does not include a tubing cap, expansion tubing, or a tubing retainer. Another difference is that assembly 200 includes leg housing 205, which is sized to receive approximately 0.5 to 3 inches of the distal end of leg tube 150. The leg housing may be coupled to the slider foot using, for example, screw 207 and cooperating nut 209.

An appropriate device, such as screw 210, may be used to secure assembly 200 to the leg tube. Leg housing 205 and screw 210 collectively form an attachment assembly. Note that this attachment assembly and the slider foot may be tilted and rotated relative to one another in a manner similar to that described above with respect to attachment assembly 20. The leg housing may be formed from the same or similar materials as those used for the tubing retainer, for example.

If desired, screw 210 may be omitted. In such an embodiment, leg housing 205 may be sized so that the inner surface of the leg housing frictionally receives and engages the outer surface of leg 150. Another alternative is to size leg housing 205 so that it may be received within cavity 155, and frictionally engage an inner surface of the leg. To facilitate this frictional engagement, portions of the leg housing may include a pliable material such as rubber.

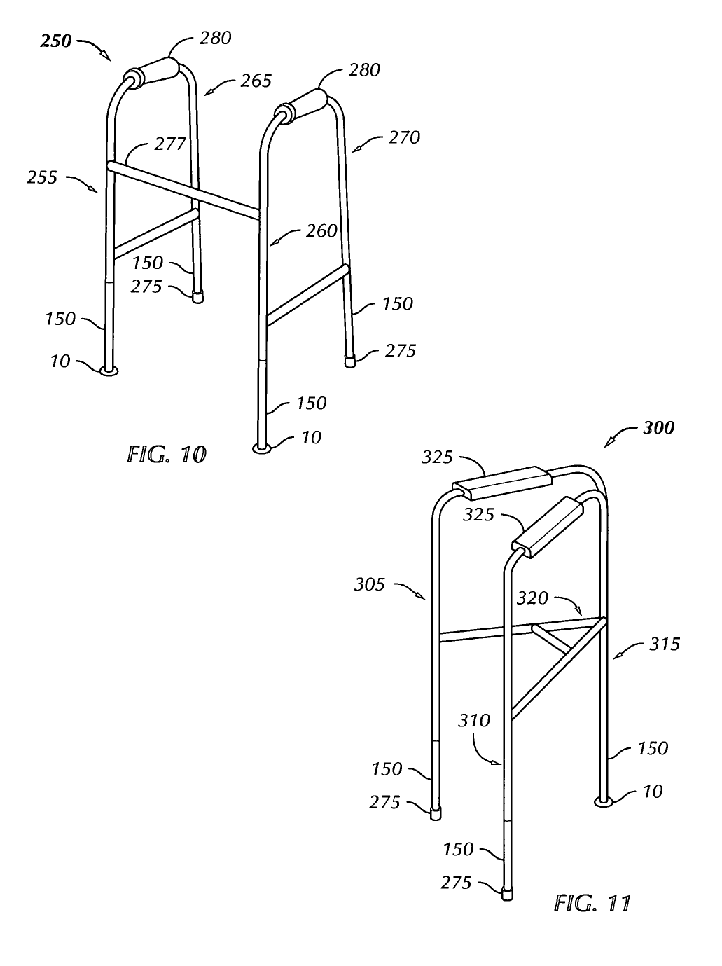

FIG. 10 is a perspective view of walker 250, which includes two walker foot assemblies 10 affixed to each of the two front legs. More specifically, walker 250 includes two front legs 255 and 260, and two rear legs 265 and 270. The distal portions of the front and rear legs are shown including a separate leg tube 150. Each of the two front legs have a walker foot assembly 10 affixed to their respective leg tubes. Both of the rear legs have rubber feet 275. Support structure 277 may be used to maintain the front and rear legs in a fixed spatial relationship.

During use, a user may grasp grips 280, and place their weight onto the walker. To advance, the user may push the walker forward causing the end portions of some or all of the legs to slide along the surface. Since front legs 255 and 260 each include a walker foot assembly, the walker may be advanced along the surface with considerably less effort than that which would be necessary if rubber feet, for example, where used on these legs.

FIG. 11 is a perspective view of a three-leg walker having one walker foot assembly affixed to its front leg. In this figure, walker 300 includes two rear legs 305 and 310, and one front leg 315. The distal portions of the front and rear legs are shown including a separate leg tube 150. The two rear legs have rubber feet 275, and the single front leg has walker foot assembly 10 affixed to the distal portion of this leg. Support structure 320 may be used to maintain the front and rear legs in a fixed spatial relationship. Optional arm pads 325 may also be used to provide comfort to the user. Walker 300 may be operated by a user in a manner similar to walker 250.

Walkers 250 and 300 may alternatively be constructed using any of the various walker foot assemblies disclosed herein. Although only the two front legs (walker 250) or the single front leg (walker 300) are shown having a walker foot assembly, alternative embodiments may are possible by configuring some or all of the legs of each respective walker with walker foot assembly 10, for example.

While the invention has been described in detail with reference to disclosed embodiments, various modifications within the scope of the invention will be apparent to those of ordinary skill in this technological field. It is to be appreciated that features described with respect to one embodiment typically may be applied to other embodiments. Therefore, the invention properly is to be construed only with reference to the claims.

What is claimed is:

1. A foot assembly for use with a walker having a plurality of leg tubes, said foot assembly comprising:
an attachment assembly for engaging a leg tube of said walker;
a slider foot comprising a bottom surface; and
a coupling device which couples said attachment assembly with said slider foot, said coupling device permitting relative movement between said attachment assembly and said slider foot.

2. The foot assembly according to claim 1, wherein said coupling device permits relative rotational movement between said attachment assembly and said slider foot.

3. The foot assembly according to claim 1, wherein said coupling device permits relative angular movement between said attachment assembly and said slider foot.

4. The foot assembly according to claim 1, wherein said coupling device permits relative rotational and angular movement between said attachment assembly and said slider foot.

5. The foot assembly according to claim 1, wherein said attachment assembly comprises:
a tubing cap;
a tubing retainer; and
expansion tubing between said tubing cap and said tubing retainer, wherein said coupling device is sized to be advanced through said tubing retainer and engage said tubing cap, and wherein manipulation of said coupling device causes said expansion tubing to frictionally engage an inner surface of said leg tube.

6. The foot assembly according to claim 5, wherein said tubing retainer comprises a plurality of annular tiers, each of said plurality of annular tiers located at a greater distance from a center of said tubing retainer and sized to receive end portions of leg tubes having correspondingly greater diameters.

7. The foot assembly according to claim 5, wherein said coupling device comprises a threaded screw which engages a cooperating threaded portion of said tubing cap.

8. The foot assembly according to claim 1, wherein said attachment assembly is adapted to frictionally engage with an inner surface of said leg tube.

9. The foot assembly according to claim 1, wherein said attachment assembly is adapted to frictionally engage with an outer surface of said leg tube.

10. The foot assembly according to claim 1, wherein said slider foot further includes an angled portion extending from said bottom surface and continuing for a defined radial distance from a central axis of said slider foot.

11. The foot assembly according to claim 10, wherein said angled portion has a radius, said radius increasing as a function of radial distance from said central axis.

12. The foot assembly according to claim 1, wherein said coupling device permits 360° of rotational movement between said attachment assembly and said slider foot.

13. The foot assembly according to claim 1, wherein said coupling device permits about 4°-10° of relative angular movement between said attachment assembly and said slider foot.

14. The foot assembly according to claim 1, wherein said slider foot is formed from a material selected from the group consisting plastic, metal, alloy, acrylonitrile-butadiene-styrene (ABS), and ultrahigh molecular weight polyethylene (UHMWPE).

15. The foot assembly according to claim 1, wherein said slider foot is substantially circular.

16. A walker, comprising:
at least three legs;
a structure for connecting said at least three legs in a fixed spatial relationship, wherein at least one of said at least three legs includes an affixed foot assembly comprising:
an attachment assembly for engaging an associated leg of said at least three legs;
a slider foot comprising a bottom surface; and
a coupling device which couples said attachment assembly with said slider foot, said coupling device permitting relative movement between said attachment assembly and said slider foot.

17. The walker according to claim 16, wherein said coupling device permits relative rotational movement between said attachment assembly and said slider foot.

18. The walker according to claim 16, wherein said coupling device permits relative angular movement between said attachment assembly and said slider foot.

19. The walker according to claim 16, wherein said coupling device permits relative rotational and angular movement between said attachment assembly and said slider foot.

20. The walker according to claim 16, wherein said attachment assembly comprises:
a tubing cap;
a tubing retainer; and
expansion tubing between said tubing cap and said tubing retainer, wherein said coupling device is sized to be advanced through said tubing retainer and engage said tubing cap, and wherein manipulation of said coupling device causes said expansion tubing to frictionally engage an inner surface of said associated leg.

21. The walker according to claim 20, wherein said coupling device comprises a threaded screw which engages a cooperating threaded portion of said tubing cap.

22. The walker according to claim 16, wherein said slider foot further includes an angled portion extending from said bottom surface and continuing for a defined radial distance from a central axis of said slider foot.

23. The walker according to claim 22, wherein said angled portion has a radius, said radius increasing as a function of radial distance from said central axis.

24. The walker according to claim 16, wherein said coupling device permits 360° of rotational movement between said attachment assembly and said slider foot.

25. The walker according to claim 16, wherein said coupling device permits about 4°-10° of relative angular movement between said attachment assembly and said slider foot.

26. The walker according to claim 16, wherein all of said at least three legs include said foot assembly.

27. The walker according to claim 16, wherein said walker further comprises:
at least four legs; and wherein
at least two of said at least four legs include said foot assembly.

28. The walker according to claim 16, wherein said walker further comprises:
at least four legs; and wherein
all of said at least four legs include said foot assembly.

29. A foot assembly for use with a walker having a plurality of leg tubes, said foot assembly comprising:
attachment means for engaging a leg tube of said walker;
sliding means for slidably supporting a structure; and
coupling means for coupling said attachment means with said sliding means and permitting relative rotational and angular movement between said attachment means and said sliding means.
